(19) United States
(12) Patent Application Publication
(10) Pub. No.: US 2024/0122158 A1
(43) Pub. Date: Apr. 18, 2024

(54) Feed-Delivery Container for Automated Dairy Feeding System

(71) Applicant: Meyers Manufacturing Corporation, Dorchester, WI (US)

(72) Inventors: Christopher J. Albright, Hazelhurst, WI (US); Brandon J. Boor, Athens, WI (US); James Kappel, Junction City, WI (US)

(21) Appl. No.: 18/485,778

(22) Filed: Oct. 12, 2023

Related U.S. Application Data
(60) Provisional application No. 63/379,830, filed on Oct. 17, 2022.

(51) Int. Cl. A01K 5/02

(52) U.S. Cl. CPC A01K 5/0208; A01K 5/0258; A01K 5/0283

(57) ABSTRACT

A feed dispenser for automated dairy feed delivery provides feed material ingredients to autonomous robots which mix and deliver the ingredients to dairy cattle. The containers have a live floor and scale and communicate with the autonomous robots to deliver the material and to schedule and monitor that delivery.

### CROSS REFERENCE TO RELATED APPLICATION

This application claims the benefit of U.S. provisional application 63/379,830 filed Oct. 17, 2022 and hereby incorporated by reference.

### STATEMENT REGARDING FEDERALLY SPONSORED RESEARCH OR DEVELOPMENT

-

### BACKGROUND OF THE INVENTION

The present invention relates to automated dairy feeding systems and in particular to an improved feed storage module for autonomous feed delivery robots.

Dairy cattle benefit from frequent feeding which promotes stable pH levels in the rumen, good rumen health, and reduces competition between animals. To this end, autonomous feed delivery systems (robotic carts) have been developed which can operate around the clock to move food from a covered storage and mixing area (a kitchen) to a feed fence where it is consumed by the cows on demand.

The kitchen supplying feed to the robotic carts may employ an overhead crane having a feed grabber which can load feed components from various pre-assigned locations into the robotic carts. Generally the feed will be composed of a mixture of grains, hay, corn silage, and other materials to produce a mixed ration. The robotic carts may include a mixer allowing the various ingredients to be blended during transportation.

The robotic cart may also include a scale to indicate when the robotic cart is filled or conversely depleted (such as can trigger a return to the kitchen). In addition the feed grabber may provide for a scale to identify when a particular location in the kitchen has no more feed and the feed grabber must select a different location.

Desirably it would be possible to anticipate when the feed components at the preassigned locations were near depletion (rather than depleted) to allow timely replenishment. Accordingly three-dimensional cameras that can assess the size of the feed pile have been proposed.

### SUMMARY OF THE INVENTION

The present invention provides an improved feed storage system employing storage containers with controllable conveyors and a scale to provide a more precise understanding of remaining feed amounts for prediction as well as improved dispensing and autonomous feed container loading. By moving multiple autonomous carts between storage containers (rather than moving a single grabber between locations), improved parallel operation is provided. The storage containers provide a self-contained conveyor system providing greatly improved loading speed and protect the feed from spoilage and loss.

In one embodiment, the invention provides a feed delivery system for use with a plurality of autonomously moving feeding devices, each feeding device having a feed container for accommodating feed received at the feed delivery system and for dispensing feed to animals at a location remote from the feed delivery system. The feed delivery system includes a storage container having a bottom wall and upstanding sidewalls defining a storage container volume and a conveyor system driven by a motor to move feed material from the storage container volume to an exit channel at a first sidewall of the storage container. The exit channel is positioned to discharge feed material into a feed container of an autonomously moving feeding device positioned adjacent to the storage container. The fee delivery system also provides an electronic scale providing an electronic weight signal indicating a weight of feed material in the storage container.

It is thus a feature of at least one embodiment of the invention to provide discrete storage volumes for feed materials that can dispense the material to robotic delivery devices allowing multiple robotic delivery devices to be loaded simultaneously from different storage containers. It is a further object of the invention to provide for monitoring of feed reserves to facilitate reloading of the storage volumes

The autonomously moving feeding devices may be coordinated by a central controller and the fee delivery system may further include a means for communicating the electronic weight signal to the central controller to control the autonomously moving feeding devices according to availability of feed material in the storage container.

It is thus a feature of at least one embodiment of the invention to make use of the scale signal also to inform the robotic delivery devices of the availability of material, allowing, for example, continued operation when a given storage container becomes empty.

The feed delivery system may include a motor controller controlling power to the motor of the conveyor system to initiate discharge of feed material into a feed container when an autonomously moving feeding device is positioned adjacent to the storage container.

It is thus a feature of at least one embodiment of the invention to eliminate the need for a central loading device that can be a bottleneck in loading materials from different repositories into the robotic delivery devices.

The feed delivery system may further include a control system controlling a speed of the motor of the conveyor system according to a rate of change of the electronic weight signal to provide improved uniformity of discharge of feed material through the exit channel.

It is thus a feature of at least one embodiment of the invention to improve delivery of feed materials by providing a consistent delivery speed that prevents overruns in systems that monitor only the weight of received material

The feed delivery system may further include a monitoring system receiving an electronic weight signal to provide a prediction of an exhaustion of feed material from the storage container based on historical changes in the electronic weight signal.

It is thus a feature of at least one embodiment of the invention to provide guidance upstream from the storage containers to delivery trucks keeping the storage containers filled

The feed delivery system may include a storage container cover covering only a portion of the storage container to provide an opening for introduction of feed material into the storage container.

It is thus a feature of at least one embodiment of the invention to provide storage containers that can extend outside of a “kitchen” building to increase storage volume while protecting the contained material and without obstructing the delivery of new material.

The storage container may provide a trailer hitch and wheels and further include a releasable power connector for connecting power to the motor from a stationary power source communicating with a controller controlling the autonomously moving feeding devices.

It is thus a feature of at least one embodiment of the invention to allow feed materials to be replenished by replacing the storage containers.

The autonomously moving feeding devices may be coordinated by a central controller, and the feet delivery system may deliver to the central controller a feed type identifier linked to the storage container.

It is thus a feature of at least one embodiment of the invention to allow flexible locations of feed materials with the robotic delivery devices adapting accordingly through identification of feed types to storage containers.

These particular objects and advantages may apply to only some embodiments falling within the claims and thus do not define the scope of the invention.

### BRIEF DESCRIPTION OF THE DRAWINGS

FIG. 1 is a perspective view in partial cutaway of a kitchen having multiple feed delivery containers per the present invention dispensing feed components to autonomous feed delivery robots;

FIG. 2 is a side elevational view in partial cutaway of one feed delivery container showing a conveyor floor for delivering feed to a set of beaters breaking the feed up and dispensing it into an autonomous robot;

FIG. 3 is a top plan view of the feed delivery container of FIG. 2 in partial cutaway;

FIGS. 4a and 4b are flow charts of a program executable by a supervisory controller in communication with the feed delivery container;

FIG. 5 is front elevational view of a kiosk that may be associated with a feed delivery container; and

FIG. 6 is a vertical elevational view of the containers of FIGS. 2 and 3 mounted on wheels to operate as a trailer.

### DETAILED DESCRIPTION OF THE PREFERRED EMBODIMENT

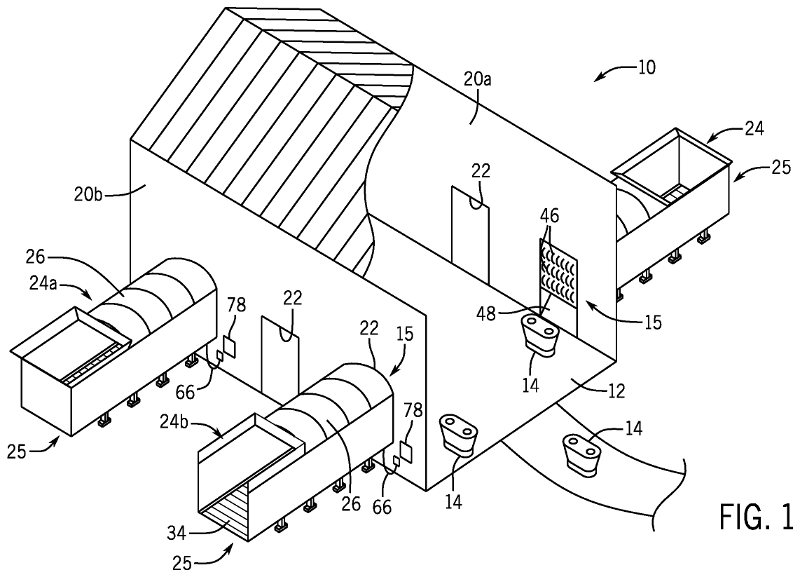

Referring now to FIG. 1, a feed kitchen 10 may provide a building enclosing a work floor 12 allowing a movement of autonomous feed delivery robots 14 between the work floor 12 and a dairy barn (not shown). The autonomous feed delivery robots 14 travel along a path 16 to deliver feed from the feed kitchen 10 to dairy cattle in the dairy barn.

Autonomous feed delivery robots 14 suitable for use with the present invention are commercially available from Lely Holding B.V. of The Netherlands under the trade name Lely Vector and are described in US patent applications 2018/0271053 and 2018/0177151 hereby incorporated by reference. Generally, the autonomous feed delivery robots 14 are in the form of battery powered carts holding hoppers with internal mixer blades that can receive feed materials through an open upper portion of the hopper, mix the received feed materials together, and dispense the feed materials downward as the autonomous feed delivery robots 14 move along a feeding fence in the dairy barn.

The feed kitchen 10 may have outer vertically extending sidewalls 20, for example, 20a and 20b, providing multiple access doors 22 sized to receive the discharge ends 15 of feed delivery containers 24a-24c therethrough. As so positioned, the feed delivery containers 24 will dispense contained feed materials to the autonomous feed delivery robots 14 moving between the feed delivery containers 24 on the work floor 12 of the kitchen 10. In one embodiment, the majority of the length of the feed delivery containers 24, including a loading end 25, will be positioned outside of kitchen 10 preserving the area of the work floor 12 for movement of the autonomous feed delivery robots 14 thereupon.

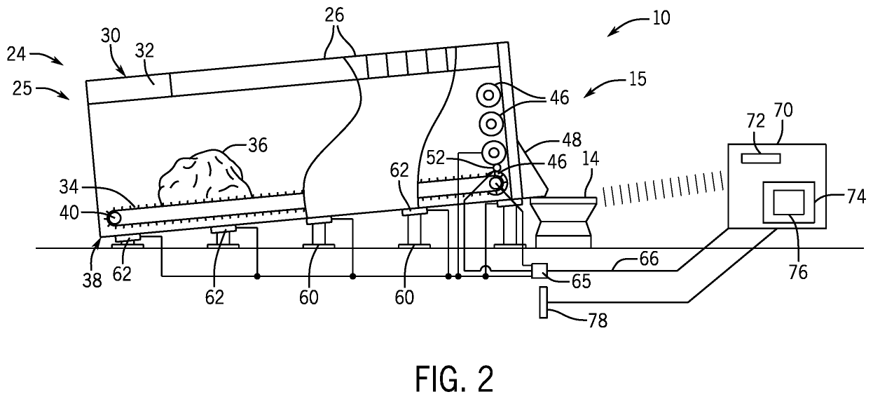

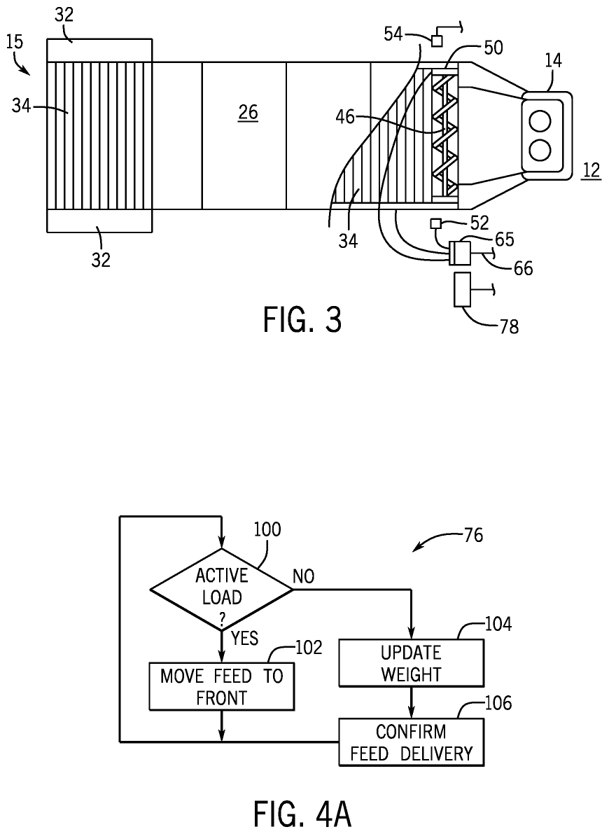

Referring also to FIGS. 2 and 3, each feed delivery container 24 may provide a generally rectangular box desirably conforming to or less than the dimensions necessary for transport on US highways, for example, having a length of greater than 10 feet and less than approximately 38 feet (between discharge end 15 and loading end 25) and a width of greater than 3 feet and less than 10 feet. In one example, the feed delivery containers 24 may be constructed of steel to provide an interconnected horizontal bottom wall extending at its periphery in four upstanding sidewalls to be generally open at the top. An upwardly convex roof 26 may cover the open top of the feed delivery container 24 over most of its length from the discharge end 15 to protect the contents of the feed delivery container 24 from weather and contamination while providing an opening 30 at the loading end 25 of the feed delivery container 24 allowing access to the container interior for the addition of feed materials therethrough.

The opening 30 may be ringed with upwardly and outwardly extending funnel-like guide plates 32 to assist in this loading process through the opening 30. Rain entering through the opening 30 will generally drain toward a rear of the feed delivery container 24 to exit through drain ports 38 aided by a general upward sloping of the bottom wall of the feed delivery container 24 from loading end 25 to the discharge end 15 as will be discussed in greater detail below. In one embodiment the rear side wall of the feed delivery container 24 may be open as well.

The feed delivery container 24 may have an active floor, in the form of a conveyor 34 having (on its upper surface) upwardly extending ribs for engaging feed material 36 placed in the feed delivery container 24. During normal operation, the conveyor 34 will move the feed material 36 forward toward the discharge end 15. The conveyor 34 may extend substantially the full width of the feed delivery container 24 to abut upwardly and outwardly sloped gutters serving to channel the feed material 36 away from the sidewalls onto the conveyor 34 eliminating substantial dead spots or the like. Either or both of a front and rear roller 40 about which the conveyor is stretched, these rollers 40 positioned at the discharge end 15 and loading end 25 of the conveyor 34, may be driven by an electric motor 42, subject to both speed control and reversibility as is understood in the art.

The discharge end 15 of the feed delivery container 24 includes a set of breaker bars 46 for breaking up feed material 36 conveyed to the discharge end 15 by the conveyor 34. The breaker bars 46 may be a set of vertically arrayed horizontally extending augers each providing either an opposite rotation or opposite helix direction to its neighbors so as to create a sideways shearing action breaking up the feed material 36 as it passes out of the discharge end 15. After passing through the breaker bars 46, the feed material 36 is discharged into a chute 48 sized to deliver the feed material into the upwardly open hoppers of an autonomous feed delivery robot 14 positioned at the other end of the chute 48. The augers of the breaker bars 46 may be controlled with a separate motor 50.

The discharge end 15 of the feed delivery containers 24 may also support a feed material sensor, for example, formed by a photoelectric beam between a light source 52 and light sensor 54 that can detect the presence of feed material 36 at the discharge end 15 and which can be used to register feed material 36 with the discharge end 15 or to detect jamming or lack of feed material flow.

As noted above, the floor of the feed delivery container 24 may be tipped upwardly from the loading end 25 to the discharge end 15, for example, by more than 5° and less than 10° for the dimensions provided. For this purpose, the feed delivery container 24 may be supported on downwardly extending legs 60 progressively greater in height toward the discharge end 15 and engaging the ground with force-spreading feet. Each of the legs 60 may be attached to the feed delivery container 24 through a load cell 62 providing a measure of the force exerted downwardly on the leg 60 by the feed delivery container 24 and its contents. It will be appreciated that the load cells 62 in combination (for example, summed) provide for the ability to measure the weight of the feed delivery container 24 and to deduce the net weight of the feed material 36 held therein. This calculation may yield a net weight by subtracting a predetermined empty weight of the empty feed delivery container 24 as is well understood in the art.

The motors 42 and 50 may be controlled by a motor controller 65, for example, providing feedback control and programmable acceleration profiles for starting and stopping of the motors, and electrical signals may be communicated between each of the load cells 62, the motor controller 65, and the light sensor 54, wirelessly or through a cable harness 66 with a controller 70 to allow control of the motors 42 and 50 and light source 52 according to signals received from the light sensor 54 and load cells 62. Electrical power may be provided by the same cable harness 66 or a separate connector. The controller 70 may also communicate with a data entry kiosk 78 allowing for the manual or automatic entry of data related to each feed delivery container 24 and may also communicate with each of the autonomous feed delivery robots 14 wirelessly.

It will be understood that the controller 70 may have one or more processors 72 communicating with an electronic memory 74 holding a stored program 76 and may be implemented as a single unit or in a distributed architecture divided among processors including, in part, on the feed delivery container 24 according to methods understood in the art.

Generally, during use of the feed delivery containers 24, feed material 36 may be loaded into the feed delivery containers 24 at various times through the opening 30 independent of discharge of feed material 36 from the feed delivery container 24, with the size of the feed delivery container 24 providing for substantial storage capacity. The deposited feed material 36 will generally be discharged in numerous smaller increments to the autonomous feed delivery robots 14 on demand. The autonomous feed delivery robots 14, under the guidance of the controller 70, move between different feed delivery containers 24 to obtain different types and amounts of material and mix those material together as they travel to a dairy barn for discharge. The autonomous feed delivery robot 14 then returns to the kitchen 10 to repeat this cycle. This movement is guided by information about what is in each feed delivery container 24 relayed to the controller 70 as well as knowledge of the availability of feed material in each feed delivery container 24 obtained by the built-in scales to the feed delivery container 24.

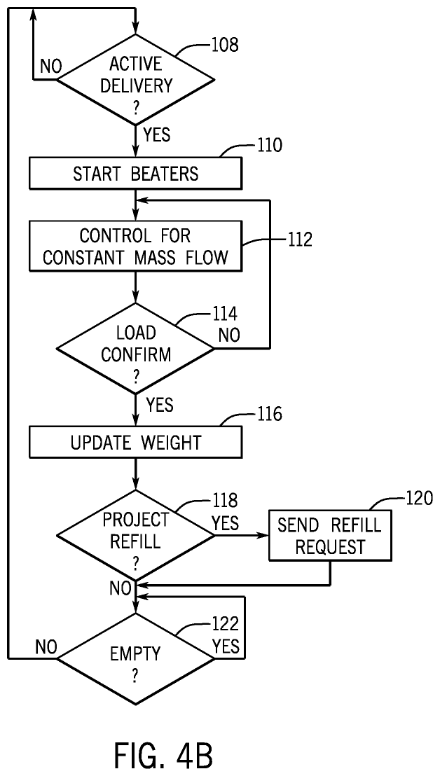

Referring now also to FIG. 4a, a program 76 executed by the controller 70, as well as controlling the autonomous feed delivery robots 14, operates to control the feed delivery containers 24 by providing a loading portion, which at decision block 100 determines whether there is an active loading of the feed delivery container 24 being conducted through the opening 30. This active loading state may be triggered, for example, by manual entry of information through kiosk 78, for example, by the operator of a vehicle loading the feed delivery container 24. Alternatively, this loading may be detected automatically, triggered by an increase in the weight of the feed delivery container 24 deduced through the load cells 62 or by an entrance sensor at opening 30 or proximity of a wireless beacon on a delivery truck, for example.
Upon detection of the introduction of feed material 36 at decision block 100, the conveyor 34 may be activated as indicated by process block 102 to move that material toward the discharge end 15 by an amount in proportion to the added weight. This serves to distribute the introduced feed material into the feed delivery container 24 and ceases when feed material 36 is detected by the light beam from light source 52 and light sensor 54.

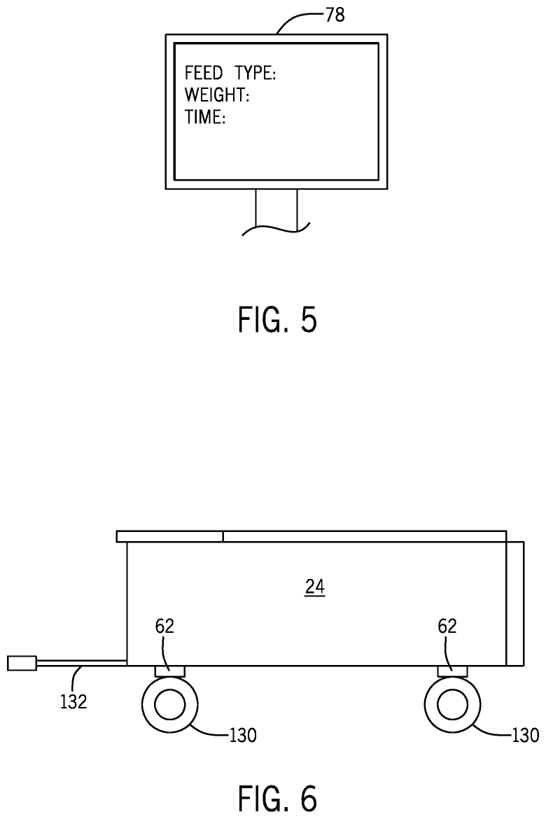

The active loading of decision block 100 may terminate either after a predetermined amount of time (during which no added weight is detected) or entry into the kiosk 78 by the operator indicating the end of the delivery or the like. At that time, as indicated by the process block 104 the net weight of feed material 36 contained in the feed delivery container 24 is updated and, at process block 106, confirmation of the type of feed material 36 and the loading time is recorded and/or subject to confirmation, for example, through the kiosk 78 shown in FIG. 5. This information may be provided remotely by the controller 70, for example, as well as to a website allowing an understanding by individuals supervising the dairy operation of the status of each of the feed delivery containers 24 including which containers are full and which containers are likely soon to be empty as will be discussed below.

Referring now to FIG. 4b, the program 76 executed by the controller 70 may also operate in a second mode (independently and concurrently with the mode of FIG. 4a) to manage an active delivery of feed material 36 to the autonomous feed delivery robots 14. This portion of the program, determined at decision block 108, is typically initiated by the controller 70 in communication with an autonomous feed delivery robot 14 positioned at the feed delivery container 24 under the chute 48 and requiring feed material 36. Upon initiation of an active delivery, as indicated by process block 110, the breaker bars 46 are activated and per process block 112 and the conveyor floor moves forward to discharge feed material 36 through the breaker bars 46 into the chute 48. This discharge may be accompanied by a monitoring of the load cells 62 to change the conveyor speed to deliver a substantially constant mass flow to the chute 48 deduced from incremental changes in weight so as to smooth out the effects of clumping or mounding of feed material 36 on the conveyor 34. Confirmation of feed delivery may also be determined through the operation of the light source 52 and light sensors 54.

At the time of delivery activation at decision block 108, the controller 70 will have determined a desired amount of feed material 36 to be delivered and may monitor that delivery using both the load cells 62 of the feed delivery container 24 and a separate scale in the autonomous feed delivery robot 14. Both of these measurements are reviewed at decision block 114 which confirms a load is complete when either the correct amount is indicated by the autonomous feed delivery robot 14 or the correct amount plus a predetermined margin (e.g., 10%) has been determined to be discharged by the feed delivery container 24. Substantial mismatch between the measurements by the autonomous feed delivery robot 14 and the feed delivery container 24 will normally produce an error message.

Assuming that the loading of the autonomous feed delivery robot 14 is properly confirmed at decision block 114, at process block 116 the recorded weight of the remaining feed material 36 in the feed delivery container 24 is updated together with the time and date of the delivery. This information is used at decision block 118 which looks at a history of deliveries and extrapolates into the future by a predetermined amount, for example, 24 hours or 48 hours, to see if that extrapolation indicates that feed material 36 in the feed delivery container 24 will have been exhausted. If so at process block 120 an alert is generated (for example, by text or email message) to request additional feed material 36 to be delivered. In this way a lack of feed material 36 can be anticipated. When there are multiple feed delivery containers 24 having the same feed material, the controller 70 may route the autonomous feed delivery robots 14 to particular of the duplicate fee delivery containers 24 in coordination with an expected delivery (for example, to completely empty that feed delivery container 24 to receive new material).

The program 76 then proceeds to decision block 122 which evaluates the current amount of feed material 36 in the feed delivery container 24 and compares it to the average discharge load computed from the historical data collected by the controller 70. If that amount remaining is less than this average, active deliveries are ceased and the feed delivery container 24 is indicated to be off-line to the controller.

Referring now to FIG. 6, the feed delivery container 24 may alternatively be provided with wheels 130 and a tow bar 132 allowing it to operate as a trailer eliminating the need for loading the feed delivery container 24 at the kitchen 10. In this case, the load cells 62 may be placed between the feed delivery container 24 and the wheels 130 to operate in the manner described above. The additional elevation of the wheels 130 may allow the bottom of the feed delivery container 24 to be substantially level with elevation of the discharge end 15 being provided simply by the extra height of the wheels 130. Alternatively, or in addition, extra height may be obtained at appropriate ramps at the kitchen 10 or through the use of elevator mechanisms such as auto levelers attached to one or both of the wheels 130. The load cells 62 may have chocks which lock them against damage during transport. In all other respects, this version may share the features of the previously described versions.

It will be appreciated that in some embodiments the conveyor belt may be replaced with one or more augers for a similar effect.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom”, and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including”, and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A feed delivery system for use with a plurality of autonomously moving feeding devices, each feeding device having a feed container for accommodating feed received at the feed delivery system and for dispensing feed to animals at a location remote from the feed delivery system, the feed delivery system comprising:
a storage container having a bottom wall and upstanding sidewalls defining a container volume;
a conveyor system driven by a motor to move feed material from the container volume to an exit channel at a first sidewall of the storage container, the exit channel positioned to discharge feed material into a feed container of an autonomously moving feeding device positioned adjacent to the storage container; and
a scale providing an electronic weight signal indicating a weight of feed material in the storage container.

2. The feed delivery system of claim 1 wherein the autonomously moving feeding devices are coordinated by a central controller and further including a means for communicating the electronic weight signal to the central controller to control the autonomously moving feeding devices according to availability of feed material in the storage container.

3. The feed delivery system of claim 2 further including a motor controller controlling power to the motor of the conveyor system to initiate discharge of feed material into a feed container when an autonomously moving feeding device is positioned adjacent to the storage container.

4. The feed delivery system of claim 1 further including a control system controlling a speed of the motor of the conveyor system according to a rate of change of the electronic weight signal to provide improved uniformity of discharge of feed material through the exit channel.

5. The feed delivery system of claim 1 further including a monitoring system receiving an electronic weight signal to provide a prediction of an exhaustion of feed material from the storage container based on historical changes in the electronic weight signal.

6. The feed delivery system of claim 1 further including a storage container cover covering only a portion of the storage container to provide an opening for introduction of feed material into the storage container.

7. The feed delivery system of claim 1 wherein the storage container provides a trailer hitch and wheels and further includes a releasable power connector for connecting power to the motor from a stationary power source communicating with a controller controlling the autonomously moving feeding devices.

8. The feed delivery system of claim 1 wherein the autonomously moving feeding devices are coordinated by a central controller, and wherein the fee delivery system may provide to the central controller a feed type identifier linked to the storage container.

9. The feed delivery system of claim 1 wherein the conveyor is selected from a belt conveyor and a screw auger.

10. The feed delivery system of claim 1 wherein the exit channel includes a beater bar.

11. The feed delivery system of claim 1 wherein the exit channel includes a funnel chute for gravity to feed the feed material to the feed container.

12. The feed delivery system of claim 11 wherein the bottom of the storage container slopes up toward the exit channel when the storage container is supported on a level surface.

13. The feed delivery system of claim 1 further including at least one sensor for a detection of material flow from the exit channel.

14. The feed delivery system of claim 1 wherein the scale provides a set of load cells distributed at support points of the storage container.
